(19) United States
(12) Patent Application Publication
(10) Pub. No.: US 2026/0285170 A1
(43) Pub. Date: Sep. 24, 2026

(54) VEHICLE BATTERY MODULE COMPRISING POWER CONVERSION DEVICE, AND VEHICLE BATTERY SYSTEM BASED ON PLURALITY OF VEHICLE BATTERY MODULES

(71) Applicants: Hyundai Motor Company, Seoul (KR); Kia Corporation, Seoul (KR)

(72) Inventors: Sung-Min HONG, Hwaseong-si Gyeonggi-do (KR); Yong-Gyu LEE, Hwaseong-si Gyeonggi-do (KR)

(73) Assignees: Hyundai Motor Company, Seoul (KR); Kia Corporation, Seoul (KR)

(21) Appl. No.: 19/473,180

(22) PCT Filed: Aug. 9, 2024
(86) PCT No.: PCT/KR2024/011929

§ 371 Date: Oct. 7, 2025

(30) Foreign Application Priority Data
Aug. 9, 2023 (KR) 10-2023-0104444

(51) Int. Cl. B60L 50/60; B60L 15/00; B60L 50/51

(52) U.S. Cl. CPC B60L 50/66; B60L 15/007; B60L 50/51; B60L 2210/10; B60L 2210/40

(57) ABSTRACT

The present invention relates to a vehicle battery module comprising a power conversion device, and a three-phase vehicle battery system based on a plurality of vehicle battery modules. The vehicle battery module comprises a battery, a DC/DC converter and a three-phase alternating current unit for outputting a three-phase alternating current module voltage. In addition, the three-phase vehicle battery system includes: a plurality of vehicle battery modules; a direct current system output terminal connecting, in parallel, the direct current module output terminals included in each of the plurality of vehicle battery modules; and a three-phase alternating current system output terminal connecting, in series for each phase, the three-phase alternating current module output terminals included in each of the plurality of vehicle battery modules.

### TECHNICAL FIELD

The present disclosure relates to a vehicle battery module including a power conversion device, and a vehicle battery system based on a plurality of vehicle battery modules.

### BACKGROUND ART

Nowadays, with increasing interest in issues, such as energy efficiency, environmental pollution, and fossil fuel depletion, eco-friendly vehicles that may practically replace internal combustion engine vehicles have been actively developed.

Eco-friendly vehicles include battery electric vehicles (BEVs) using batteries as a power source, fuel cell electric vehicles (FCEVs) using fuel cells as a primary power source, and hybrid electric vehicles (HEVs) using both an engine and a motor as driving devices.

These eco-friendly vehicles may be broadly defined as electric vehicles (xEVs) and have in common the characteristics of being motor-driven vehicles and electrified vehicles that run by driving a motor with electricity from a high-voltage power source, such as a battery or fuel cell.

Electric vehicles are equipped with high-voltage batteries supplying power to the motor, and the high-voltage batteries supply power to power electronics components within the vehicles, such as motors, while being charged with and discharged of electricity during vehicle operation. Also, since the size and type of voltages required for each type of power electronics component are different, various types of power conversion devices are required to convert an output voltage of high-voltage batteries. Here, the power conversion device has to convert the high voltage output from high voltage batteries, so a high voltage power conversion device is required, and because the high voltage batteries are expensive, the production cost may increase.

### DISCLOSURE OF INVENTION

### Technical Problem

An aspect of the present disclosure is to enable the use of power conversion devices operable at low voltage by allowing a conventional electric vehicle driving system operating at high voltage to be configured with series/parallel combination of a plurality of battery modules operating at low voltage.

Another aspect of the present disclosure is to configure a battery system by connecting standardized battery modules in series or in parallel, thereby outputting voltages of various magnitudes depending on the intended purpose and meeting the diverse specifications required by each vehicle model.

The objects of the present disclosure are not limited to the aforementioned tasks, and other tasks not mentioned will be clearly understood by those skilled in the art from the following description.

### Solution to Problem

In order to achieve the above-mentioned objects, the present disclosure provides a vehicle battery module and a three-phase vehicle battery system configured based on the vehicle battery module.

According to an aspect of the present disclosure, a vehicle battery module includes a battery outputting a battery voltage, a DC/DC converter converting the battery voltage into a direct current (DC) module voltage lower than the battery voltage and outputs the DC module voltage, and a three-phase alternating current (AC) unit converting the battery voltage into a three-phase AC module voltage and outputting the three-phase AC module voltage, wherein the three-phase AC unit includes a first inverter converting the battery voltage into a primary AC voltage and a multi-winding transformer converting the primary AC voltage into a plurality of secondary AC voltages and is configured to convert the plurality of secondary AC voltages into the three-phase AC module voltage.

According to an aspect of the present disclosure, a three-phase vehicle battery system includes a plurality of vehicle battery modules including a DC module output terminal outputting a DC module voltage that is lower than an internal battery voltage from the internal battery voltage and a three-phase AC module output terminal outputting a three-phase AC module voltage having the same phase difference, a DC system output terminal configured as the DC module output terminals respectively included in the plurality of vehicle battery modules are connected in parallel, and a three-phase AC system output terminal configured as the three-phase AC module output terminals respectively included in the plurality of vehicle battery modules are connected in series by phases.

### Advantageous Effects of Invention

According to an embodiment of the present disclosure, manufacturing costs may be reduced by applying a power conversion device operable at low voltage using a standardized battery module operable at low voltage.

Furthermore, even if the required voltage or specifications are different for each vehicle model, standardized battery modules may be combined in series or in parallel to meet various specifications, and since mass production is possible, production costs may be reduced.

Furthermore, according to an embodiment of the present disclosure, since a battery module system may be configured by connecting standardized battery modules in series or in parallel, space usage efficiency may be increased, thereby reducing overall volume, and in the event of a failure, each battery module may be replaced, thereby facilitating repairs, and balance control for each battery module may be implemented, thereby increasing overall energy efficiency.

### BRIEF DESCRIPTION OF DRAWINGS

FIG. 1 illustrates an electric vehicle driving system including a general high-voltage battery pack.

FIG. 2 is a block diagram illustrating a battery module and a three-phase battery system according to an embodiment of the present disclosure.

FIG. 3 is a block diagram illustrating a three-phase AC unit according to an embodiment of the present disclosure.

FIGS. 4 to 6 illustrate a battery module according to an embodiment of the present disclosure.

FIG. 7 is a diagram illustrating a connection structure between a plurality of battery modules according to an embodiment of the present disclosure.

FIG. 8 illustrates a three-phase battery system according to an embodiment of the present disclosure.

FIG. 9 is a diagram illustrating an inverter structure according to an embodiment of the present disclosure.

### MODE FOR THE INVENTION

Hereinafter, embodiments of the present disclosure are described with reference to the accompanying drawings. The following description is provided to aid in the comprehensive understanding of methods, devices, and/or systems disclosed in the particularities. However, the following description is merely exemplary and not provided to limit the present disclosure.

In the following description of the present disclosure, a detailed description of known functions and configurations incorporated herein will be omitted when it would render the subject matter of the present disclosure unclear. The terms used in the present specification are defined in consideration of functions used in the present disclosure, and may be changed according to the intent or conventionally used methods of clients, operators, and users. Accordingly, definitions of the terms should be understood on the basis of the entire description of the present specification. Terms used in the following description are merely provided to describe embodiments of the present disclosure and are not intended to be limiting of the inventive concept. As used herein, the singular forms “a,” “an” and “the” are intended to include the plural forms as well, unless the context clearly indicates otherwise. It will be further understood that the terms “comprises” or “has” when used in this specification, specify the presence of stated features, integers, steps, operations, elements, or a portion or combination thereof, but do not preclude the presence or addition of one or more other features, integers, steps, operations, elements, or a portion or combination thereof.

In addition, a “module voltage” described below may refer to a voltage output from a battery module, and a “system voltage” may refer to a voltage output from a battery system configured based on the battery module.

The battery module described below may include a vehicle battery module, and the battery system may include a three-phase vehicle battery system.

The present disclosure may be used not only in vehicles but also in various devices to which battery modules and battery systems are applicable.

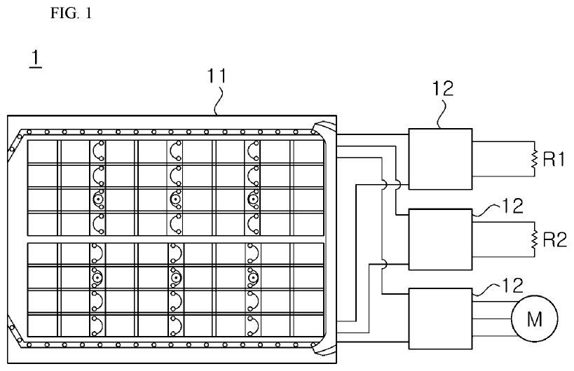

FIG. 1 illustrates an electric vehicle driving system including a general high-voltage battery pack.

Referring to FIG. 1, the electric vehicle driving system (1) may include a general high-voltage battery pack (11) and various power conversion devices (12).

Here, the general high-voltage battery pack (11) is configured with a series/parallel combination of a plurality of battery cells and may not include a separate power conversion device. The general high-voltage battery pack (11) may output a single high voltage (e.g., 480 V to 806.4 V). The power conversion device (12) may be provided in a separate space, separate from the high-voltage battery pack (11), and the high-voltage battery pack (11) and the power conversion device (12) may be connected via a high-voltage cable.

Meanwhile, electric vehicles have electrical loads with various functions, and since each electrical load requires a different voltage level and type, a variety of power conversion devices (12) are required. However, the electric vehicle driving system (1) including the general high-voltage battery pack (11) is based on a single high voltage, the electric vehicle driving system (1) has to use the power conversion device (12) for high voltages.

More specifically, the electric vehicle driving system (1) converts a high voltage output from the general high-voltage battery pack (11) into a low direct current (DC) voltage to provide a driving voltage to a low-voltage load (R1) or to charge a low-voltage battery. At this time, energy loss may occur during the process of converting power from high voltage to low voltage, reducing efficiency. Furthermore, since the voltage has to be significantly lowered, a separate transformer may be required.

The electric vehicle driving system (1) may convert the voltage output from the general high-voltage battery pack (11) to provide a driving voltage to a high-voltage load (R2) and generate a high-voltage three-phase alternating current (AC) power source to provide a driving voltage to a motor (M). Inverters operating at high voltage generally use SiC power semiconductors for high-voltage switching. However, SiC power semiconductors have low yields, as compared to high demand, so that the SiC power semiconductors may be difficult to be smoothly supplied, and high price thereof may increase production costs.

Furthermore, in the electric vehicle driving system (1) has a structure in which the high-voltage battery pack (11) and power conversion devices are separated, each occupying separate space, and since high-voltage cables have to be used to connect them, which may be bulky.

Furthermore, the electric vehicle driving system (1) may generate significant heat due to the high voltage output of the high-voltage battery pack (11) and require a water cooling system to control the heat generation, resulting in a bulky and heavy system.

Also, according to the electric vehicle driving system (1), since the specifications are different depending on the vehicle type, the battery system has to be individually designed according to the specifications of the vehicle type, which may complicate the process and increase production costs.

The battery system according to an embodiment of the present disclosure described below may be configured with a series/parallel combination of a plurality of battery a power modules, and each battery module may include conversion device operating at low voltage.

In other words, the battery system according to an embodiment of the present disclosure is configured based on battery modules, and each battery module includes a power conversion device operating at low voltage. Therefore, the battery system may not only store/release electrical energy but also perform power conversion in the battery module. Therefore, the battery module according to an embodiment of the present disclosure may convert DC to AC or convert the magnitude of battery power and output the same as needed.

In addition, the outputs of each battery module may be connected in series to form a high-voltage output or in parallel to form a large-current output, and the voltage of each battery module may be monitored for balancing control.

Hereinafter, a battery module and a battery system including the same according to an embodiment of the present disclosure will be described in more detail.

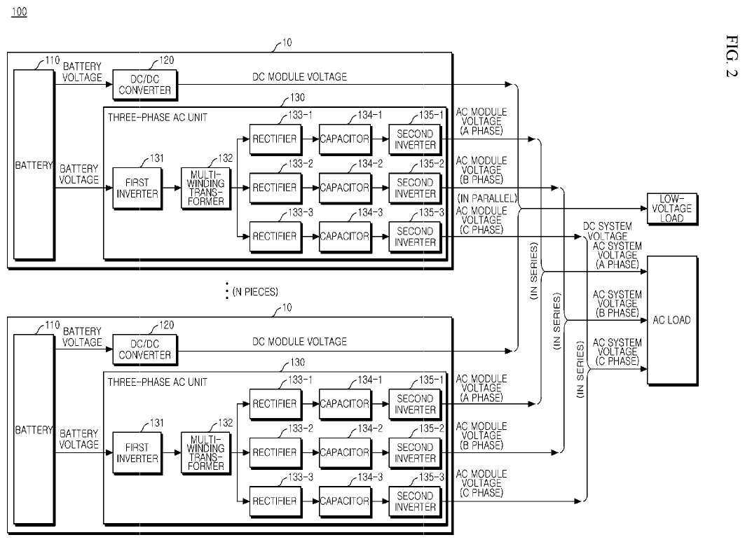

FIG. 2 is a block diagram illustrating a battery module and a three-phase battery system according to an embodiment of the present disclosure.

Referring to FIG. 2, a battery module (10) according to an embodiment of the present disclosure may include a battery (110), a DC/DC converter (120), and a three-phase AC unit (130). The DC/DC converter (120) may convert the battery voltage into a DC module voltage lower than the battery voltage and output the same.

Furthermore, the three-phase AC unit (130) may convert the battery voltage into a three-phase AC module voltage comprising an A-phase AC module voltage, a B-phase AC module voltage, and a C-phase AC module voltage and output the same. The three-phase AC unit (130) may include a first inverter (131) converting the battery voltage into a primary AC voltage and a multi-winding transformer (132) converting the primary AC voltage into a plurality of secondary AC voltages. In an embodiment, the multi-winding transformer (132) may have a 1:1 transformer ratio. The three-phase AC unit (130) may include rectifiers (133-1, 133-2, 133-3) converting the secondary AC voltage into a DC voltage, capacitors (134-1, 134-2, 134-3) connected in parallel with output terminals of the rectifiers, and second inverters (135-1, 135-2, 135-3) converting a capacitor voltage into an AC module voltage.

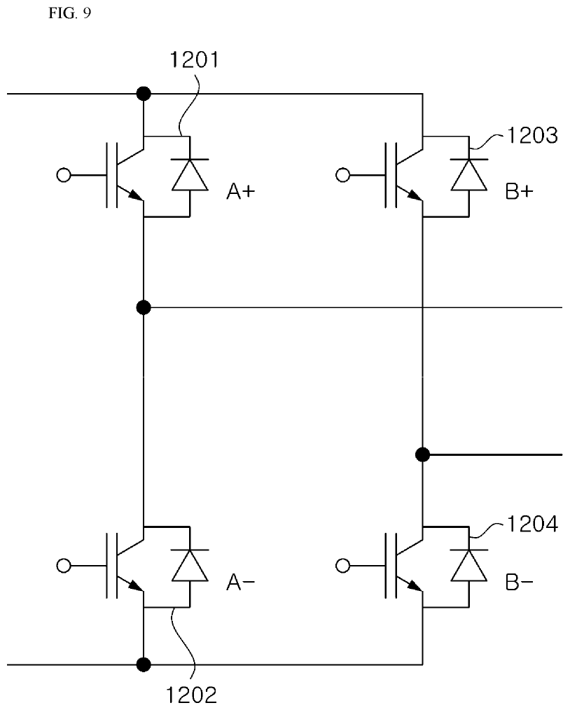

The first inverter (131) may operate as an inverter during motor operation and as a rectifier during regeneration. Furthermore, the rectifiers (133-1, 133-2, 133-3) may operate as rectifiers during motor operation and as inverters during regeneration. As illustrated in FIG. 9, the first inverter (131) and rectifiers (133-1, 133-2, 133-3) may be configured in an H-bridge form in which diodes are connected in parallel with four switches, respectively.

During motor operation, the first inverter (131) may convert the battery voltage to an AC module voltage, and the rectifiers (133-1, 133-2, 133-3) may convert the AC voltage to a DC voltage. In contrast, during regeneration, the rectifiers (133-1, 133-2, 133-3) may function as inverters, and the first inverter (131) may function as a rectifier.

In this manner, the first inverter (131) and the rectifiers (133-1, 133-2, 133-3) may function as an inverters or rectifiers, depending on whether the motor is driven or regenerated, and this may be implemented using diodes connected in parallel in the H-bridge form, as illustrated in FIG. 9.

Also, the DC system voltage may be configured by connecting a plurality of DC module voltages in parallel, and the DC system voltage and the DC module voltage may have the same magnitude. The DC system voltage may serve as a supply voltage for a low-voltage load.

In addition, the three-phase AC system voltage may be configured by connecting a plurality of three-phase AC module voltages in series for each phase, and when N three-phase AC module voltages are connected in series, the three-phase AC system voltage may be configured as N times the three-phase AC module voltage. Furthermore, the three-phase AC system voltage may be a supply voltage for a three-phase AC load and may include AC system voltages having A, B, or C phase. In this case, the A, B, or C phase AC system voltages may be configured as AC voltages having the same magnitude and a phase difference of 120 degrees.

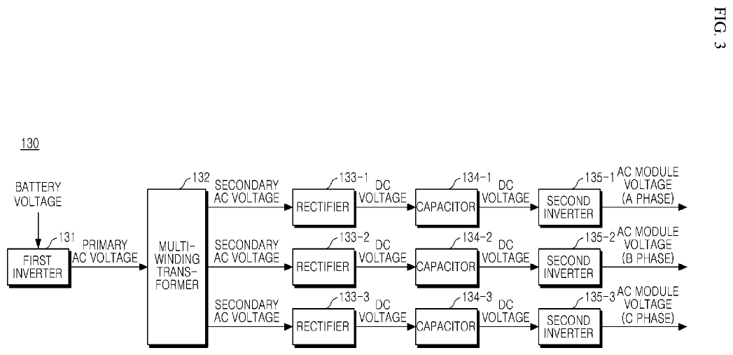

FIG. 3 is a block diagram illustrating a three-phase AC unit according to an embodiment of the present disclosure.

Referring to FIG. 3, the three-phase AC unit (130) according to an embodiment of the present disclosure may include the first inverter (131), the multi-winding transformer (132), the rectifiers (133-1, 133-2, 133-3), the capacitors (134-1, 134-2, 134-3), and second inverters (135-1, 135-2, 135-3).

The first inverter (131) may convert the battery voltage into a primary AC voltage, and the multi-winding transformer (132) may transform the primary AC voltage into a plurality of secondary AC voltages.

Furthermore, the plurality of secondary AC voltages may be output as AC module voltages via the rectifier (133), the capacitor (134), and the second inverter (135). Here, the AC module voltage may correspond to one phase of the three-phase AC module voltage. More specifically, the rectifier (133) may convert one of the plurality of secondary AC voltages into a DC voltage, and the capacitor (134) may be connected in parallel with an output terminal of the rectifier (133). Furthermore, the second inverter (135) may convert a DC voltage across the capacitor (134) into an AC module voltage and output the same.

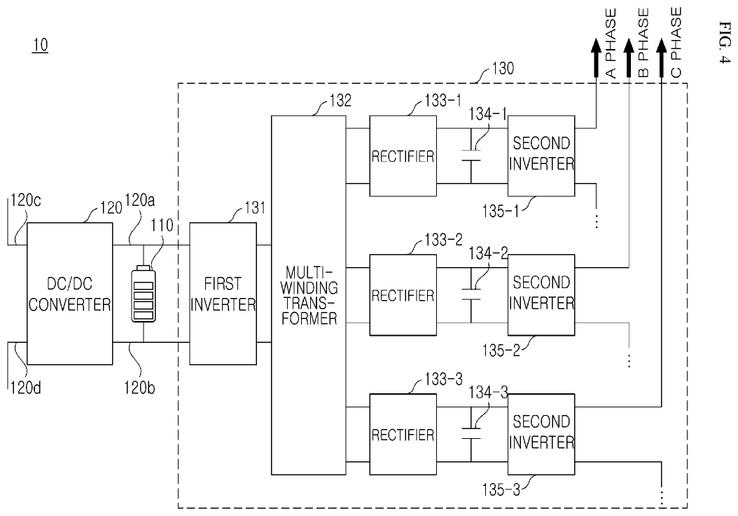

FIG. 4 illustrates a battery module according to an embodiment of the present disclosure.

Referring to FIG. 4, the battery module (10) according to an embodiment of the present disclosure may include the battery (110), the DC/DC converter (120), and the three-phase AC unit (130).

The battery (110) may output a battery voltage and charge or discharge electrical energy. The battery voltage constitutes a base voltage of the battery module (10) and may provide an input voltage to the DC/DC converter (120) and the three-phase AC unit (140).

Also, the battery (110) may have a lower battery voltage than the general high-voltage battery pack (11) described in FIG. 1. Therefore, the vehicle battery module (10) according to an embodiment of the present disclosure may adopt a power conversion device operable at low voltage, thereby reducing manufacturing costs.

Also, the battery module (10) according to an embodiment of the present disclosure may output voltages of various sizes and types depending on the series/parallel combination of the battery modules (10), and thus, the single-size battery module (10) may be used to be applied to various vehicle models and reduce manufacturing costs.

Furthermore, a three-phase battery system outputting a high-voltage AC system voltage may be may be configured by connecting three-phase AC module voltages of the battery modules (10) in series. Also, the battery modules (10) may be combined in parallel to form a battery system in which a large current flows.

Also, the DC/DC converter (120) may convert the battery voltage into a DC module voltage lower than the battery voltage and output the same.

Also, the DC module voltage may be set as a driving voltage for a low-voltage load in a vehicle. For example, the low-voltage load may be an electric load, such as various lamps, radio sets, and infotainment systems in an electric vehicle. The DC module voltage may be set to a driving voltage of 12 V, 24 V, or 48 V, which is the driving voltage for the low-voltage load. However, the magnitude of the voltage mentioned herein are merely an example and may be set to voltages having various magnitudes depending on the design.

The DC/DC converter may include input terminals (120a, 120b) and output terminals (120c, 120d). The input terminals (120a, 120b) of the DC/DC converter may be connected in parallel with the battery 110 to receive the battery voltage, and the output terminals (120c, 120d) of the first DC/DC converter may output a DC module voltage. Hereinafter, the DC/DC converter output terminals (120c, 120d) may also be referred to as DC module output terminals outputting the DC module voltage.

Furthermore, the output terminals (120c, 120d) of the DC/DC converter may be directly connected to a low-voltage load to provide the DC module voltage.

In an embodiment, one end (120d) of the output terminal of the DC/DC converter may be grounded, and the other end (120c) may be connected to a low-voltage load to output the DC module voltage. In another embodiment, both ends (120c, 120d) of the output terminal of the DC/DC converter may be connected to both ends of the low-voltage load to output the DC module voltage.

Also, the three-phase AC unit (130) may convert the battery voltage into a three-phase AC module voltage and output the same. The three-phase AC module voltage may include an A-phase AC module voltage, a B-phase AC module voltage, and a C-phase AC module voltage. The three-phase AC unit (130) may include an input terminal and an output terminal. The input terminal of the three-phase AC unit may be connected in parallel with the battery to receive the battery voltage, and the output terminal of the three-phase AC unit may output the three-phase AC module voltage.

Hereinafter, the output terminal of the three-phase AC unit may also be referred to as an output terminal of the three-phase AC module outputting the three-phase AC module voltage. The three-phase AC unit (130) may be configured to supply AC power to an AC load according to the three-phase AC module voltage. Also, the three-phase AC unit (130) may be connected in series with three-phase AC units included in other battery modules by phases to supply AC power to the AC load. In this case, the AC load may be a load, such as a motor that uses the three-phase AC voltage as a driving voltage.

More specifically, the three-phase AC unit (130) may include the first inverter (131), the multi-winding transformer (132), the rectifiers (133-1, 133-2, 133-3), the capacitors (134-1, 134-2, 134-3), and the second inverters (135-1, 135-2, 135-3).

The first inverter (131) may convert the battery voltage into a primary AC voltage. In addition, the first inverter (131) may convert the battery voltage into an AC voltage having a frequency suitable for input to the multi-winding transformer (132).

The multi-winding transformer (132) may convert a primary AC voltage into a plurality of secondary AC voltages. The primary AC voltage may refer to a primary voltage of the transformer, and the secondary AC voltage may refer to a secondary voltage of the transformer. Furthermore, the multi-winding transformer (132) may have a 1:N transformer ratio, preferably 1:1 transformer ratio. The transformer ratio of the multi-winding transformer may be determined by considering the ratio of the battery voltage to the three-phase AC system voltage.

Furthermore, the rectifier (133) may convert the secondary AC voltage into a DC voltage and may perform the function of converting a half-cycle or full-cycle of the AC voltage into a DC voltage.

Also, the capacitor (134) may be connected in parallel with the output terminal of the rectifier (133), and the DC voltage output from the rectifier (133) and the voltage across the capacitor (134) may be the same.

In addition, the second inverter (135) may convert the voltage across the capacitor (134), i.e., the DC voltage output from the rectifier (133), into an AC module voltage and output the same. Furthermore, the second inverter (135) may convert the DC voltage to have a frequency suitable for the input of an AC load (e.g., a motor).

Also, the battery (110) may be configured to be connected to the input terminals (120a, 120b) of the DC/DC converter and the input terminals (131a, 131b) of the first inverter in parallel.

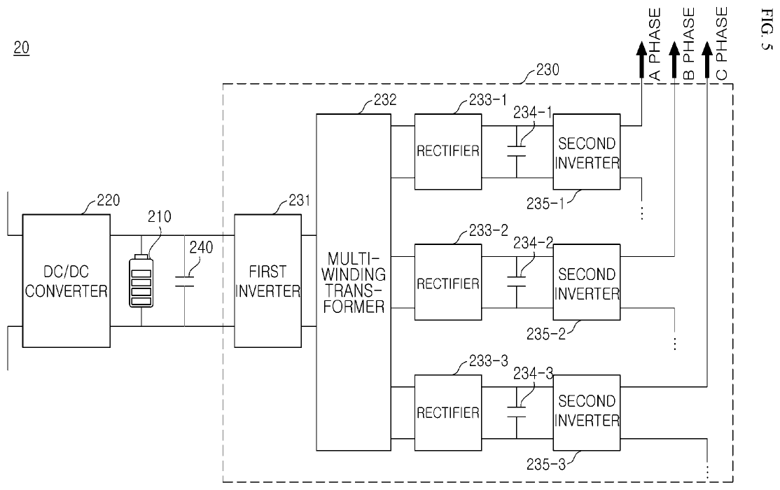

FIG. 5 illustrates a battery module according to an embodiment of the present disclosure.

Referring to FIG. 5, the battery module (20) according to an embodiment of the present disclosure may include a battery (210), a DC/DC converter (220), a three-phase AC unit (230), and a common capacitor (240). The common capacitor (240) may be connected in parallel with the battery (210). The battery module (20) illustrated in FIG. 5 may include all the components of the battery module (10) illustrated in FIG. 4 and may further include the common capacitor (240).

According to the battery module (20) according to an embodiment of the present disclosure, a single common capacitor may be shared instead of applying separate capacitors for each inverter and converter device, thereby reducing volume, and since low-voltage capacitors may be used, production costs may be reduced.

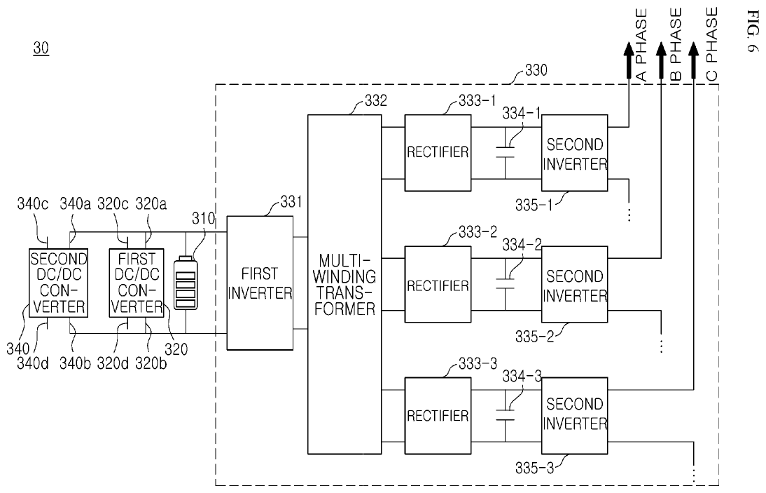

FIG. 6 illustrates a battery module according to an embodiment of the present disclosure.

Referring to FIG. 6, a battery module (30) may include a battery (310), a first DC/DC converter (320), a three-phase AC unit (330), and a second DC/DC converter (340). The first DC/DC converter (320) may be the same as the DC/DC converters (120, 220) illustrated in FIG. 4 or 5. In addition, the battery module (30) may include all of the components of the battery module (10) illustrated in FIG. 4 and may further include the second DC/DC converter (340).

In this case, input terminals (340a, 340b) of the second DC/DC converter (340) may receive the battery voltage, and output terminals (340c, 340d) of the second DC/DC converter (340) may output a second DC module voltage. Furthermore, when configuring a single-phase battery system using the battery module (30), the output terminals (340c, 340d) of the second DC/DC converter (340) included in the single-phase battery system may be connected in series to form a second DC system output terminal, which may output a high-voltage DC voltage and supply the same to a high-voltage load.

In addition, when configuring a three-phase battery system using the battery modules (30), the second DC system output terminal of each phase may be connected in parallel with the second DC system output terminal of another phase. Also, the second DC system output terminal may then provide a high DC voltage to a high-voltage load required by a vehicle.

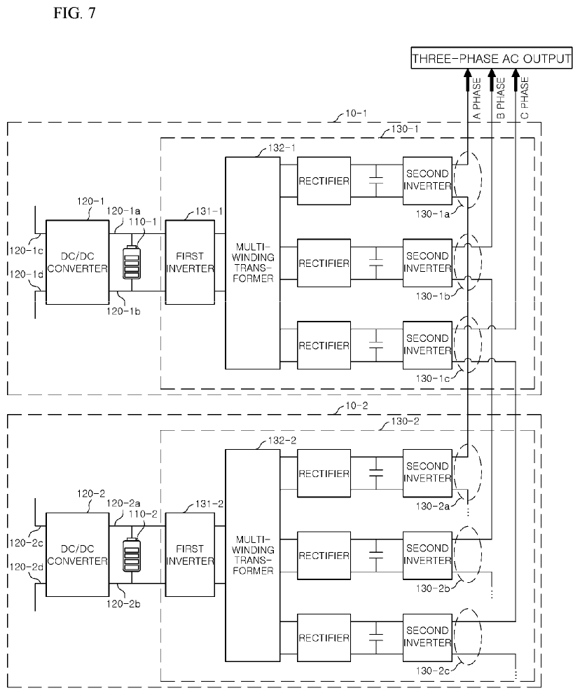

FIG. 7 is a diagram illustrating a connection structure between a plurality of battery modules according to an embodiment of the present disclosure.

Referring to FIG. 7, a first battery module (10-1) and a second battery module (10-2) may have the same configuration and may be configured with the same structure.

Furthermore, as described above with reference to FIG. 4, the first battery module (10-1) and the second battery module (10-2) may each include batteries (110-1, 110-2), DC/DC converters (120-1, 120-2), and three-phase AC units (130-1, 130-2). Alternatively, as described above with reference to FIG. 5, the first battery module (10-1) and the second battery module (10-2) may further include a common capacitor.

In addition, a plurality of battery modules may be connected to form a three-phase battery system, and the connection relationship between the plurality of battery modules included in the three-phase battery system may be the same as the structure illustrated in FIG. 7.

More specifically, an A-phase AC module output terminal (130-1a) included in the three-phase AC unit (130-1) included in the first battery module (10-1) may be connected in series with an A-phase AC module output terminal (130-2a) included in the three-phase AC unit included in the second battery module (10-2). Furthermore, a B-phase AC module output terminal (130-1b) included in the three-phase AC unit included in the first battery module (10-1) may be connected in series with a B-phase AC module output terminal (130-2b) included in the three-phase AC unit included in the second battery module (10-2). Furthermore, a C-phase AC module output terminal (130-1c) included in the three-phase AC unit included in the first battery module (10-1) may be connected in series with a C-phase AC module output terminal (130-2c) included in the three-phase AC unit included in the second battery module (10-2).

At this time, the output terminal of the three-phase AC unit may refer to the output terminal of the second inverter. Also, when the AC module voltage is set to 100 V, two three-phase AC units (130-1, 130-2) connected in series may output an AC voltage of 200 V. The AC module voltage may refer to the maximum AC voltage, the root mean square (RMS), etc., and generally refers to the root mean square (RMS).

The output terminals (120-1c, 120-1d) of the DC/DC converter included in the first battery module (10-1) and the output terminals (120-2c, 120-2d) of the DC/DC converter included in the second battery module (10-2) may be connected in parallel. In an embodiment, one end (120-1d) of the output terminal of the DC/DC converter included in the first battery module (10-1) may be grounded, and one end (120-2d) of the output terminal of the DC/DC converter included in the second battery module (10-2) may be grounded. The other end (120-1c) of the output terminal of the DC/DC converter included in the first battery module (10-1) and the other end (120-2c) of the output terminal of the DC/DC converter included in the second battery module (10-2) may be connected in parallel to output the DC module voltage. Furthermore, the output terminal of the DC/DC converter, in which the other ends of the output terminals of the DC/DC converters are connected in parallel, may output the DC module voltage and may be connected to a low-voltage load using the DC module voltage as a driving voltage to provide voltage.

To summarize, in the first battery module (10-1) and the second battery module (10-2), the output terminals having the same phase of the three-phase AC unit may be connected in series, and the output terminals of the DC/DC converter may be connected in parallel.

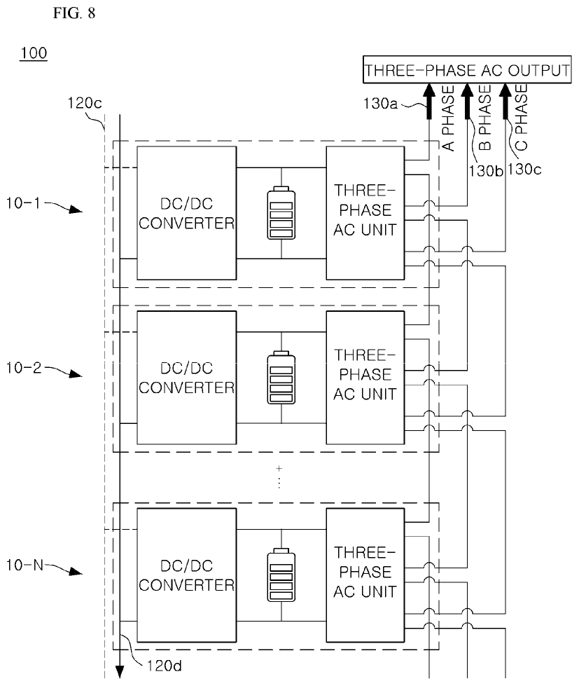

FIG. 8 illustrates a three-phase battery system according to an embodiment of the present disclosure.

Referring to FIG. 8, a three-phase battery system (100) according to an embodiment of the present disclosure may include a plurality of battery modules (10-1, 10-2, . . . , 10-N). Also, each of the plurality of battery modules (10-1, 10-2, . . . , 10-N) included in the three-phase battery system (100) may be the same as the battery modules (10, 20, 30) illustrated in FIGS. 4 to 6. Furthermore, the plurality of battery modules (10-1, 10-2, . . . , 10-N) included in the three-phase battery system (100) may have the connection structure between battery modules illustrated in FIG. 7.

According to an embodiment of the present disclosure, the three-phase battery system (100) may include a DC system output terminals (120c, 120d) configured by connecting the DC module output terminals included in each of the plurality of battery modules in parallel. In this case, the DC system output terminals (120c, 120d) may output a DC system voltage, which may have the same magnitude as that of the DC module voltage output from the output terminal of the DC/DC converter.

Furthermore, the three-phase battery system (100) according to an embodiment of the present disclosure may include three-phase AC system output terminals (130a, 130b, 130c) configured by connecting the output terminals of three-phase AC units included in each of a plurality of battery modules in series by phases. The three-phase AC system output terminal may output A phase, B phase, and C phase AC system voltages, and the AC system voltage may have a magnitude of an integer (N) multiple pf the AC module voltage output from the output terminal of the three-phase AC unit. Meanwhile, the three-phase AC system output terminal may provide AC power to an AC load.

To sum up, the three-phase battery system (100) may provide various output voltages, including a DC system voltage and an AC system voltage, by connecting the individual components of the plurality of battery modules in series and/or in parallel.

Also, an electric vehicle may include AC loads, such as a low-voltage load (R1) operating at low voltage, a high-voltage load (R2) operating at high voltage, and a motor (M) operating at high-voltage three-phase AC voltage. Furthermore, the low-voltage load may use the DC system voltage as a driving voltage, and the AC load may use the AC system voltage as a driving voltage.

Also, the three-phase battery system (100) may further include a controller (not shown). The controller may individually control each battery module may individually control the inverter unit and the DC/DC converter included in each battery module. Therefore, according to an embodiment of the present disclosure, energy efficiency may be improved by performing balancing control for each power conversion device and each battery module.

Furthermore, if a problem occurs in some of the N battery modules, the controller may control the shutdown of only a defective battery module, thereby ensuring the reliability of the entire system.

Furthermore, since the controller may individually control each battery module, even if deterioration occurs differently in each battery module, the deterioration performance of each battery module may be actively controlled.

FIG. 9 is a diagram illustrating a structure of an inverter according to an embodiment of the present disclosure.

Referring to FIG. 9, the first inverter 131 or the rectifier 133 may include a plurality of Si-MOSFET (Metal Oxide Semiconductor Field Effect Transistor) devices (1201, 1202, 1203, 1204) and may be configured as an H-bridge single-phase inverter structure.

Conventional electric vehicle systems primarily use SiC power semiconductors. These SiC power semiconductors offer high efficiency and fast switching speeds, but are expensive.

Furthermore, conventional electric vehicle systems sometimes use insulated gate bipolar transistors (IGBTs) at low voltage. While IGBTs are relatively inexpensive, they may have slow switching speeds.

Meanwhile, Si-MOSFET devices offer fast switching speeds and are relatively inexpensive, but their performance degrades at high voltage, and thus, Si-MOSFET devices are difficult to apply in conventional high-voltage electric vehicle systems.

Since the battery module according to an embodiment of the present disclosure operates at low voltage, Si-MOSFET devices may be used in inverters. Therefore, the inverter included in the battery module according to an embodiment of the present disclosure may use a plurality of Si-MOSFET devices, thereby reducing production costs, while speeds. Accordingly, fuel achieving fast switching efficiency may be improved and a vehicle driving range may be increased. Furthermore, as the driving range increases, battery capacity may be reduced, thereby reducing costs.

Furthermore, the inverter according to an embodiment of the present disclosure is configured as an H-bridge single-phase inverter structure, thereby maintaining stability even at high currents.

Furthermore, while FIG. 9 illustrates an H-bridge circuit using four Si MOSFETs as an example, it is also possible to configure an H-bridge circuit by connecting a plurality of Si MOSFETs in parallel with enable high-current switching.

As described above, the present disclosure, as a technology for replacing conventional electric vehicle driving systems that operate at high voltage by connecting standardized battery modules operating at low voltage in series or in parallel, may provide various outputs by connecting battery modules in series or in parallel as needed.

While the present disclosure has been particularly shown and described with reference to exemplary embodiments thereof, a person skilled in the art will understand that the invention is not limited to the disclosed exemplary embodiments but may be variously modified within the scope of the present disclosure. Therefore, the scope of the present disclosure should not be limited to the above-described embodiments but should be determined by all changes or modifications derived from the scope of the appended claims and equivalents of the following claims.

Description of Reference Characters

| | |
|---|---|
| 1: CONVENTIONAL ELECTRIC | 11: HIGH-VOLTAGE |
| VEHICLE DRIVING SYSTEM | BATTERY PACK |
| 12: POWER CONVERSION DEVICE | |
| 10, 20: BATTERY MODULE | 110: BATTERY |
| 120: DC/DC CONVERTER | 130: THREE-PHASE AC UNIT |
| 131: FIRST INVERTER | 132: MULTI-WINDING |
| | TRANSFORMER |
| 133: RECTIFIER | 134: CAPACITOR |
| 135: SECOND INVERTER | |
| 100: THREE-PHASE | |
| BATTERY MODULE SYSTEM | |

1. A vehicle battery module comprising:
a battery outputting a battery voltage;
a DC/DC converter converting the battery voltage into a direct current (DC) module voltage lower than the battery voltage and outputs the DC module voltage; and
a three-phase alternating current (AC) unit converting the battery voltage into a three-phase AC module voltage and outputting the three-phase AC module voltage,
wherein the three-phase AC unit includes a first inverter converting the battery voltage into a primary AC voltage and a multi-winding transformer converting the primary AC voltage into a plurality of secondary AC voltages and is configured to convert the plurality of secondary AC voltages into the three-phase AC module voltage.

2. The vehicle battery module of claim 1, wherein the three-phase AC unit further includes a rectifier converting one of the plurality of secondary AC voltages into a DC voltage, a capacitor connected in parallel with an output terminal of the rectifier, and a second inverter converting a voltage of the capacitor into an AC module voltage corresponding to one phase of the three-phase AC module voltage.

3. The vehicle battery module of claim 1, further comprising a capacitor connected in parallel with the battery.

4. The vehicle battery module of claim 1, wherein the battery is configured to be connected in parallel with an input terminal of the DC/DC converter and an input terminal of the first inverter.

5. The vehicle battery module of claim 1, wherein an output terminal of the DC/DC converter is configured to be connected in parallel with a low-voltage load using the DC module voltage as a driving voltage.

6. The vehicle battery module of claim 1, wherein the three-phase AC unit is configured to supply AC power to an AC load using a driving voltage that is an integer multiple of the three-phase AC module voltage.

7. The vehicle battery module of claim 2, wherein an output frequency of the first inverter and an output frequency of the second inverter are configured to be different from each other.

8. A three-phase vehicle battery system comprising:
a plurality of vehicle battery modules including a direct current (DC) module output terminal outputting a DC module voltage that is lower than an internal battery voltage from the internal battery voltage and a three-phase alternating current (AC) module output terminal outputting a three-phase AC module voltage having the same phase difference;
a DC system output terminal configured as the DC module output terminals respectively included in the plurality of vehicle battery modules are connected in parallel; and
a three-phase AC system output terminal configured as the three-phase AC module output terminals respectively included in the plurality of vehicle battery modules are connected in series by phases.

9. The three-phase vehicle battery system of claim 8, wherein
each of the plurality of vehicle battery modules includes:
a battery outputting a battery voltage;
a DC/DC converter converting the battery voltage into a DC module voltage lower than the battery voltage and outputs the DC module voltage; and
a three-phase AC unit converting the battery voltage into the three-phase AC module voltage and outputting the three-phase AC module voltage,
wherein the three-phase AC unit includes a first inverter converting the battery voltage into a primary AC voltage and a multi-winding transformer converting the primary AC voltage into a plurality of secondary AC voltages and is configured to convert the plurality of secondary AC voltages into the three-phase AC module voltage.

10. The three-phase vehicle battery system of claim 9, wherein the three-phase AC unit further includes a rectifier converting one of the plurality of secondary AC voltages into a DC voltage, a capacitor connected in parallel with an output terminal of the rectifier, and a second inverter converting a voltage of the capacitor into an AC module voltage corresponding to one phase of the three-phase AC module voltage.

11. The three-phase vehicle battery system of claim 9, wherein the battery is configured to be connected in parallel with an input terminal of the DC/DC converter and an input terminal of the first inverter.

12. The three-phase vehicle battery system of claim 8, wherein the DC system output terminal is configured to be connected in parallel with a low-voltage load using the DC module voltage as a driving voltage.

13. The three-phase vehicle battery system of claim 8, wherein the three-phase AC system output terminal is configured to be connected to an AC load using a driving voltage that is an integer multiple of a magnitude of the three-phase AC module voltage.

14. The three-phase vehicle battery system of claim 8, wherein the three-phase AC module output terminal outputs different AC module voltages having the same magnitude and the same phase difference.

15. The three-phase vehicle battery system of claim 8, wherein the number of the plurality of vehicle battery modules is set based on a voltage magnitude of the three-phase AC system output terminal and a magnitude of the AC module voltage.

16. The three-phase vehicle battery system of claim 9, wherein
each of the plurality of vehicle battery modules further includes a second DC/DC converter converting the battery voltage into a second DC module voltage higher than the DC module voltage and outputs the second DC module voltage, and
wherein the three-phase vehicle battery system further comprising a second DC system output terminal configured as output terminals of the second DC/DC converters respectively included in the plurality of vehicle battery modules are connected in series.
